(19) United States
(12) Patent Application Publication
(10) Pub. No.: US 2022/0126147 A1
(43) Pub. Date: Apr. 28, 2022

(54) DEVICE AND METHOD OF ANTI-INFLAMMATION CAPSULE

(71) Applicant: AAI ADVANCED AUTOMOTIVE INNOVATIONS INC., Ontario (CA)

(72) Inventor: Sarit BARON, Raanana (IL)

(21) Appl. No.: 17/427,752

(22) PCT Filed: Feb. 5, 2020
(86) PCT No.: PCT/IB2020/050923

§ 371 Date: Aug. 2, 2021

Related U.S. Application Data
(60) Provisional application No. 62/801,140, filed on Feb. 5, 2019.

(51) Int. Cl. A62C 3/07; A62C 35/13; A62C 99/00

(52) U.S. Cl. CPC A62C 3/07; A62C 99/0045; A62C 35/13

(57) ABSTRACT

The present invention provides a fire suppressant system for vehicles and method for preventing fire outbreak within a vehicle's fuel tank or expulsion thereof.

### FIELD OF THE INVENTION

The present invention relates to fire suppression. More particularly, to devices for fire suppression of combustible liquid in confined spaces.

### BACKGROUND

Accidents involving vehicles are quite common, to the extent that nearly every driver at some time will be involved in a minor or major accident. Minor accident is defined herein as an accident that does not endanger life or limb, whereas major accident is defined as an accident that is life endangering.

Physical bruising due to impact following a vehicle accident is an obvious result due to the extraordinary level of impact which the vehicle has been subjected to. However, accidents may involve also fire due to, e.g., combustibility and explosiveness of the vehicles' fuels. Various safety devices were developed to reduce physical bruising, such as seat belts and airbags. However the outbreak of a fire or an explosion can have a disastrous effect upon the passengers of the vehicle or nearby bystanders.

Fuel tank combustion of a vehicle pose a serious risk. Such combustion may result due to various situations, such as an accident, penetration of a projectile to the fuel tank, external fire (that heats the fuel within the fuel tank and lead to its combustion), static electricity ignition during fueling, etc.

It is thus desirable to provide a fire prevention safety system for vehicles that operates when needed, e.g., following an extraordinary impact, or due to elevated temperature level, or both.

Various attempts have been made to reduce the risk of fuel tank combustion and prevention thereof. For instance, in aircraft, the inside surface of fuel tank and other compartments are covered with panels containing a frangible honeycomb structure filled with a fire suppressant substance, such that penetration/damage to the compartment causes the release of the fire suppressant that interferes with air reaching the fuel and acts to prevent a fire from starting as well as extinguishing any existing fire. However, in order for this technique to be effective, a substantive damage to the fuel tank is needed. U.S. Pat. No. 8,894,014 also describes a firing prevention structure of a fuel tank.

CN 203865181 provides a fireproof fuel tank, in which its components are wrapped by at least one fireproof heat-insulation sets.

Other methods uses a device that detects flames and automatically releases a suppressant, such as freon. Such detection is usually done by infra-red and ultra-violet optical detectors and thermocouple heat detectors. However, these techniques require a lapse of time after fuel tank rupture and flame start, which means that the fire might get out of hand.

U.S. Pat. No. 5,425,426 relates to fire extinguishing methods and associated systems that do not involve halocarbons and which are highly effective in extinguishing fires, even when relatively small quantities of chemicals are used. EP 867367 provides devices and methods for inerting gaseous constituents occupying the ullage space of a fuel tank to provide an elevated temperature carbon bed that is effective to convert oxygen contained within air to carbon dioxide, to reduce the risk of a fire or an explosion in a partially emptied fuel tank.

U.S. Pat. No. 3,930,541 describes means to suppress fuel fires due to rupture of a fuel tank by armor-piercing projectiles in military vehicle.

### SUMMARY OF INVENTION

In a first aspect, the present invention provides a vehicle fire prevention system, comprising: (a) a sealed container with an integral opening mechanism attached to the inner wall of a vehicle's fuel tank; (b) a fire suppressant residing within said container; and (c) a controller connected to one or more emergency sensors and to a fuel gage sensor, said controller designed to activate said opening mechanism, wherein upon occurrence of an emergency situation detected by said one or more emergency sensors, the controller activates said opening mechanism to release a measured amount of said fire suppressant into said fuel tank, said measured amount being calculated according to the amount of fuel within the fuel tank as indicated by said fuel gage sensor.

In a second aspect, the present invention provides a method for preventing fire outbreak within a vehicle's fuel tank or expulsion thereof, the method comprising attaching a fire suppressant sealed container as defined above to the inner wall of said vehicle's fuel tank, such that upon occurrence of an emergency situation detected by said one or more emergency sensors, the controller activates said opening mechanism to release a measured amount of said fire suppressant into said fuel tank, said measured amount being calculated according to the amount of fuel within the fuel tank as indicated by said fuel gage sensor, thereby preventing fire outbreak or expulsion.

### BRIEF DESCRIPTION OF DRAWINGS

FIG. 1 illustrates an embodiment of the fire suppressant system comprising a capsule of the invention holding a fire suppressant and placed in a fuel tank, the capsule being connected to a controller.

FIG. 2 illustrates an embodiment of the fire suppressant system comprising a capsule of the invention holding a fire suppressant and placed in a fuel tank, the capsule being connected to a controller which is connected to the vehicle's airbag sensor.

### DETAILED DESCRIPTION

In the following detailed description of various embodiments, reference is made to the accompanying drawings that form a part thereof, and in which are shown by way of illustration specific embodiments in which the invention may be practiced. It is understood that other embodiments may be utilized, and structural changes may be made without departing from the scope of the present invention.

The present invention relates to safety systems for vehicles such as automobiles, specifically to safety systems that prevent outbreak or spread of fire in the vehicle (especially its fuel tank) following an emergency situation such as an accident, collision, other extraordinary impact, fire, excessive heat, or any combination thereof.

Fire extinguishing involves the creation of an atmosphere that is incapable of sustaining combustion. This is especially significant in confined spaces. One common method for fire extinguishing includes introduction of volatile halocarbons, such as Halon 1301, into the space to be protected. Halocarbons have excellent fire extinguishing capacity which is attributable to their being inhibitors of combustion. Halocarbons actively interfere with the chemical reactions taking place in the flame and effectively inhibit them.

Many other fire extinguishing materials are presently known. For instance, inert gaseous diluents, such as carbon dioxide, nitrogen water vapor; and powders based on mineral salts, such as carbonates, bicarbonates, alkali metal chlorides, ammonium phosphates, etc.

Notably, fire extinguishing methods that are based on inert gaseous dilution require relatively large amounts of diluent and are considered less effective and reliable compared to extinguishing with halocarbons.

Fire extinguishing with powders is performed by dispensing the powder aerosol, which envelops the flame to thereby suppress it. However, such powders has a limited capacity for interrupting the chain reactions and putting out a fire, and the powder tend to agglomerate during storage, which hinders its dispensing when needed.

Aerosol efficiency depends to some extent on the chemical composition of the solid particles. It has been demonstrated that the best fire propagation inhibiting properties are displayed by carbonates, bicarbonates, chlorides, sulfates, and oxides of metals such as, but not limited to, those belonging to Group IA of the Periodic Table, with the exception of Li and Fr. It was further determined that the strongest aerosol inhibitors are strontium sulfates and cesium sulfates, with potassium chlorides and sodium chlorides being not quite as effective, and with potassium bicarbonates and sodium bicarbonates being somewhat less effective.

Alternative fire extinguishing developments include powder admixed with a thixotropic gel (U.S. Pat. No. 4,234,432); creating storing reaction precursors instead of actual powders (US Statutory Invention No. H349 to Krevitz et al.); and using pyrotechnic compounds, such as 3,6-bis(1H-1,2,3,4-tetrazol-5-ylamino)-1,2,4,5-tetrazine (BTATz), for exploding and dispersing a fire suppressant powder.

However, known techniques and system are either not suitable for use in fuel tanks of vehicles, or are insufficiently effective. As such a need exist for a simple and effective fire suppressant system for vehicles.

Accordingly, the present invention provides a vehicle fire prevention system, comprising: (a) a sealed container with an integral opening mechanism attached to the inner wall of a vehicle's fuel tank; (b) a fire suppressant residing within said container; and (c) a controller connected to one or more emergency sensors and to a fuel gage sensor, said controller designed to activate said opening mechanism, wherein upon occurrence of an emergency situation detected by said one or more emergency sensors, the controller activates said opening mechanism to release a measured amount of said fire suppressant into said fuel tank, said measured amount being calculated according to the amount of fuel within the fuel tank as indicated by said fuel gage sensor. In specific embodiments, the fuel gage sensor is the vehicle's fuel gage sensor.

The term “measured amount” as used herein refers to any amount needed of the fire suppressant for preventing outbreak of fire. In specific embodiments, the term “measured amount” refers to the entire content of the sealed container.

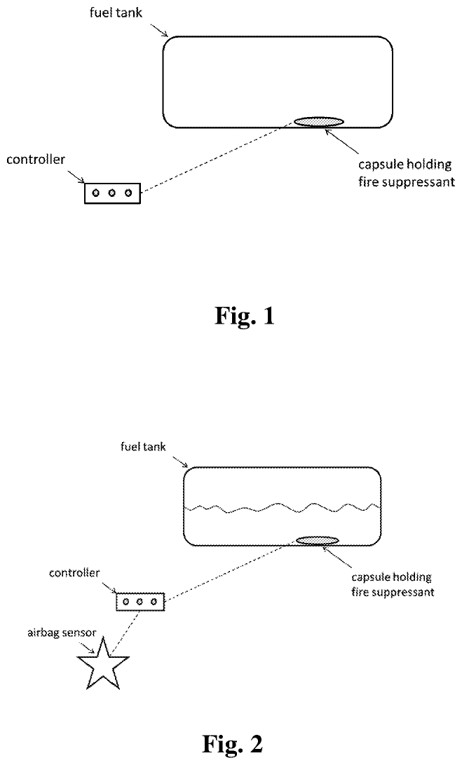

In certain embodiments, the fire suppressant system of the invention comprises: (a) a fire suppressant capsule/container holding a fire suppressant, said capsule is equipped with an integral opening mechanism; and (b) a controller for opening said opening mechanism, wherein said capsule is designed to be placed/assembled within a fuel tank of said vehicle, and said controller is designed to open said opening mechanism and release said fire suppressant into said fuel tank when needed, i.e. in case of an emergency situation. An exemplary system of the invention is illustrated in FIG. 1.

In certain embodiments, the fire suppressant system of the invention comprises: (a) a capsule/container equipped with an integral opening mechanism and holding a fire suppressant, the capsule/container is designed to be placed/assembled within a fuel tank of the vehicle; and (b) a controller associated with the capsule/container and designed to open/activate the opening mechanism, wherein the controller is designed to open the opening mechanism and release said fire suppressant into the fuel tank when needed, i.e. in case of an emergency situation.

The terms “capsule”, “container” and “sealed container” as used herein interchangeably refer to any vessel that holds the fire suppressant and is designed to be placed within a fuel tank and/or attached to its inner wall.

In some embodiments, the fire prevention system (or the capsule/container) further comprises a fire suppressant dispersion mechanism, optionally as part of said opening mechanism, wherein the dispersion mechanism is activated by said controller during activation of said opening mechanism. Non-limiting examples of such dispersion mechanism are expulsion, spraying, injecting, etc. In specific embodiments, the dispersion mechanism is an explosive composition that is insensitive to ordinary handling and environmental conditions but is detonated instantly upon activation by said controller and/or under extreme duress or impact.

In some embodiments, the fire prevention system further comprises at least one sensor for detecting an emergency situation, e.g. an accelerometer for detecting a crash, and a thermometer for detecting a fire or excessive heat, and designed to activate said opening mechanism and/or said dispersion mechanism, either directly or via said controller. In specific embodiments, the at least one sensor is an integral part of said fire suppressant capsule/container.

In certain embodiments of the fire prevention system of any of the embodiments herein the one or more emergency sensors comprise any one of: a thermometer for detecting a fire or excessive heat; an accelerometer for detecting a crash/collision; and an airbag opening sensor; or any combination thereof.

In certain embodiments, the controller of the invention is associated-with/connected-to the vehicle's airbag system. In specific embodiments, the controller receives data from the vehicle's airbag system. Accordingly, activation of the vehicle's airbag system serves as an indication to the controller (or activates the controller) to release said fire suppressant.

In certain embodiments, the fire suppressant comprises aluminum oxide, antimony oxide, sodium bicarbonate, or potassium carbonate.

In certain embodiments, the emergency situation is selected from an accident, a collision, an extraordinary impact, a fire, excessive heat, or any combination thereof.

In another aspect, the present invention provides a method for preventing fire outbreak within a vehicle's fuel tank or expulsion thereof, the method comprising attaching a fire suppressant sealed container as defined above to the inner wall of said vehicle's fuel tank, such that upon occurrence of an emergency situation detected by said one or more emergency sensors, the controller activates said opening mechanism to release a measured amount of said fire suppressant into said fuel tank, said measured amount being calculated according to the amount of fuel within the fuel tank as indicated by said fuel gage sensor, thereby preventing fire outbreak or expulsion. In specific embodiments, the fuel gage sensor is the vehicle's fuel gage sensor.

In certain embodiments, the method according to the invention for preventing fire outbreak within a vehicle's fuel tank or expulsion thereof, comprising placing a fire suppressant capsule/container as described above inside a fuel tank of said vehicle, such that upon an emergency situation, the controller of the capsule automatically opens said capsule to disperse the fire suppressant into the fuel tank to thereby prevent fire outbreak or expulsion due to combustion of fuel within the fuel tank.

In certain embodiments, the method further comprises a step of associating or connecting the controller of the fire prevention system of the invention to the vehicle's airbag system, such that activation of said vehicle's airbag system also activates the controller (or indicates thereto) to release the fire suppressant.

In certain embodiments, the activation of the controller is automatic, i.e. in response to an emergency situation that is detected by sensors associated with said controller and/or due to the activation of the vehicle's airbag.

In certain embodiments, the activation of the controller is manual, i.e. by a user in response to an emergency situation.

In certain embodiments, the emergency situation is selected from an accident, a collision, an extraordinary impact, a fire, excessive heat, or any combination thereof.

The present invention further provides a novel fire prevention safety system for vehicles, that dispenses fire suppressant following an emergency situation such as fire, extraordinary impact or increased temperature. In specific embodiments, following such emergency situation the system further: shuts off the ignition system; and/or shuts off the flow of fuel to the engine. Thus, in specific embodiments, the safety system of the invention focuses upon three specific fire areas of a vehicle: the fuel tank, the engine and the ignition system.

The present invention provides safety systems for preventing outbreak or spread of fire in a vehicle, especially the vehicle's fuel tank. In certain embodiments, the safety system of the invention is fully automatic and is positioned mainly or completely inside the vehicle's fuel tank. In specific embodiments, the capsule/container holding the fire suppressant is placed inside the vehicle's fuel tank, and is optionally anchored in place by any suitable means, such as glue, welding or is part of the original manufacturing of the engine.

Some advantages of the safety systems of the present invention include: does not interfere with normal function of the vehicle, and does not occupy space in the fuel tank; low to no power need; simple and easy installation; computability to all vehicle types; low to no maintenance; long shelf life; reaction speed (response within 5 ms); fire suppressant speed; efficient distribution of the fire suppressant; and fail-safe activation mechanisms—the system can be activated in various overlapping ways, e.g. via a detector(s), due to activation of the vehicle's airbag, due to heat/fire and/or manually.

A fuel tank fire prevention capsule/container according to any of the embodiments above and incorporated within a vehicle's fuel tank as part of the fire suppressant system of the invention, automatically dispenses fire suppressant into the fuel tank when the vehicle is subject to a predetermined level of impact or when the temperature at a predetermined location in the vehicle, e.g., at the vicinity of the fuel tank, reaches a predetermined level. The fire prevention system can also be arranged to operate only when both the impact conditions and the high temperature conditions have occurred. The fire prevention system can also be arranged to operate manually by, e.g., the driver, a passenger, or a rescue personal present on site.

The speed of releasing the fire suppressant into the fuel tank is of upmost importance: if released too slow the fire might spread and get out of control or an expulsion may occur. Accordingly, in certain embodiments of the fire suppressant system of any of the embodiments above, the capsule/container holding the fire suppressant further comprises a fire suppressant dispersion mechanism, optionally as part of said opening mechanism, such as by expulsion, spraying, or any other immediate release mechanism. In specific embodiments, the dispersion mechanism is an explosive composition (layer) that is insensitive to ordinary handling and environmental conditions but is detonated instantly upon activation by said controller and/or under extreme duress or impact.

Such dispersion mechanism is essential for rapid dispersion of the fire suppressant within the fuel tank to prevent expulsion and/or fire onset.

When selecting an explosive composition (layer), one should also ensure that both the initial composition thereof and its explosion products are incapable of triggering fire onset. One should also take into consideration the amount being used, i.e. to prevent a too large explosion that rupture the fuel tank and spread the fuel all over.

In certain embodiments, the fire suppressant/prevention system of any of the embodiments above further comprises at least one sensor for detecting an emergency situation, e.g. an accelerometer for detecting a crash, and a thermometer for detecting a fire or excessive heat, and designed to activate said opening mechanism and/or said dispersion mechanism, either directly or via said controller. This feature further shortens the time required to release the fire suppressant into the fuel tank. In specific embodiments, the at least one sensor is an integral part of said fire suppressant capsule/container. Alternatively, or in addition, sensors can be external to the fuel tank and be associated with the controller, such as thermometer for detecting external heating of the vehicle/fuel tank.

The fuel tank fire prevention system of the invention thus includes sensing means (e.g. sensors) for sensing either a predetermined distortion of the fuel tank or a predetermined temperature level in proximity thereof, or both, wherein said sensing means either triggers directly the release of the fire suppressant, or activates the controller which is responsible for the release of the fire suppressant.

For example, impact conditions are sensed by a distortion sensing unit that may be located either inside the fuel tank, e.g. within the capsule/container, or outside the fuel tank, e.g. within the controller, but in any case the distortion sensing unit is associated with the controller and/or the capsule/container. In certain embodiments, the distortion sensing unit is arranged to react to a distortion or deformation of some surface portion of the fuel tank.

In other examples, temperature conditions may be sensed by a thermal device, either incorporated in the capsule/container inside the fuel tank, or placed anywhere else while being associated with the controller and/or the capsule/container.

In certain embodiments, the system of the invention is designed to be associated-with/connected-to the vehicle safety mechanisms/systems, such as the safety belts and/or the airbag system. In such cases, the activation of such safety mechanisms/systems triggers the controller to release the fire suppressant into the fuel tank. Notably, in certain embodiments, the controller is designed to identify the severity of the emergency situation that caused the activation of the vehicle's safety mechanisms/systems, and to determine whether or not to release the fire suppressant. In alternative embodiments, the controller receives data from both the vehicle's safety mechanisms/systems and other sensors, such as temperature sensor. In specific embodiments, the controllers determines the amount of fire suppressant to be released according to, e.g., the amount of fuel within the fuel tank (received from a fuel gage sensor, that is optionally the vehicle's fuel gage sensor).

Accordingly, in specific embodiments of the fire suppressant system of any of the embodiments above, and as illustrated in FIG. 2, the controller is associated with the vehicle's airbag system, such that activation of the airbag also activates the controller to release said fire suppressant from the capsule.

The term “emergency situation” as used herein refers to any situation that is life threatening and involves a vehicle. Non-limiting examples are an accident, a collision, an extraordinary impact, a fire, excessive heat, or any combination thereof.

In certain embodiments, the present invention relates to fire suppressant systems for use in vehicles equipped with fuel tanks, such as motorcycles, motorcars, airplanes, etc. Specifically, the invention provides fire suppressant systems that are equipped with any suitable chemical solution, suitable powder, or suitable composition thereof that is capable of preventing or extinguishing fire in a fuel tank, and that can be stored/encapsulated in a capsule/container, and subsequently released therefrom into the fuel within a fuel tank.

The present invention further provides a method for preventing fire outbreak within a vehicle's fuel tank or expulsion thereof, the method comprising placing a fire suppressant capsule/container as defined hereinabove inside a fuel tank of the vehicle, and assembling the controller, such that upon an emergency situation, the controller automatically opens said capsule/container to disperse the fire suppressant into the fuel tank to thereby prevent fire outbreak or expulsion due to combustion of fuel within the fuel tank.

In specific embodiments, the method further comprises a step of associating the controller of said capsule with the vehicle's airbag system, such that activation of said airbag also activates the controller to release said fire suppressant from the capsule.

The system and method of the invention comprise an arrangement, wherein the controller or an alternative manual mechanism, such as a lever or button, are positioned near the driver to enable manual control thereby, for breaking open the capsule/container and releasing the fire extinguishing material into the fuel tank according to the driver's desire/need.

Accordingly, in certain embodiments of the system and method of the invention, the activation of the controller is manual, i.e. by a user in response to an emergency situation. Alternatively, or in addition, the activation of the controller is automatic, i.e. in response to an emergency situation that is detected by sensors associated with said controller and/or due to the activation of the vehicle's airbag.

The present invention further provides a novel method for fire prevention and fire extinguishing in a vehicle's fuel tank. A key feature of the present invention involves the release of a fire suppressant directly into the fuel within the fuel tank. Optionally, the fire suppressant is released into the fuel tank, not necessarily directly into the fuel itself. The fire suppressant is designed to immediately prevent fire outbreak and suppress existing fire, by transferring the fuel in the fuel tank into a non-combustible substance. This is achieved, e.g., due to a rapid chemical reaction between the fuel and the fire suppressant that is released from the capsule/container.

Notably, the fire extinguishing capacity of known techniques, such as powders and aerosols is dependent on the particles' size and is limited by their ability to prevent oxygen from the flames and/or to isolate the fire-fuel from the flame and/or the environment/air. Contrary to such techniques, the present invention is directed towards making the fire-fuel inadequate for burning: upon release (from the capsule/container) of the fire suppressant into the liquid fuel, the fire suppressant molecules interact with the fuel to generate incombustible material.

In certain embodiments, the fire suppressant used in the system and method of the invention is actually two, three or more individual chemicals/components that are stored separately from one another in the capsule/container, such that the opening of the capsule/container and their release into the fuel enables the chemical reaction between the different chemicals/components and the fuel to thereby transfer the fuel into an incombustible material.

Non-limiting examples of such individual chemicals that can be used in the system of the invention are: an oxidant, such as potassium perchlorate, potassium dichromate, potassium nitrate, potassium chlorate, cesium nitrate or the like; and a reactant capable of acting as a reducing agent, which may be one or more of various organic materials, such as rubber, polymeric materials, epoxy resin, phenol formaldehyde resin, and the like, or which may be phosphorus, sulfur, and the like. In specific embodiments, one individual chemical is a filler such as potassium chloride, wherein the filler is designed to regulate the temperature by absorbing some of the heat generated during the chemical reaction between the chemicals and/or the fuel (and optionally from the surroundings). Simultaneously, the filler may also serve as a source of compounds that have fire-extinguishing properties.

In certain embodiments, the fire suppressant in the system of any one of the embodiments above comprises aluminum oxide, antimony oxide, sodium bicarbonate, or potassium carbonate.

The precise composition and amount of the fire suppressant in the system of the present invention is selected/determined according to type of fuel being used in the vehicle and the size of the fuel tank. There are many possible combinations of components making up the fire suppressant according to the invention. However, what is critical to the methods and systems of the present invention is not the precise composition but the in situ reaction, namely the speed and efficiency of transferring the fuel into an incombustible material after the release of the fire suppressant therein.

Non-limiting example of such a fire suppressant are: aqueous film-forming foam (AFFF) and water solution; water, AFFF, and Halon 1301; water and monoammonium phosphate powder; 30% calcium chloride and water solution; 50% ethylene glycol and water solution; 70% ethyl alcohol and water solution; Halon 1301 and water mixture; propane; monoanimonium phosphate powder mixed with Halon 1301; FC-218; HFC-227ea; HFC-125; and Pentane.

The capsule/container of the system according to the present invention may be prepared in any convenient way. For instance, the components of the fire suppressant may be dry mixed, and then mechanically pressed to form pellets or tablets of desirable size and shape for packing in the capsule/container. Alternatively, each capsule/container may be pressured-filled with the fire suppressant when it is in a powder form, or simply filled with it when it is in a liquid or paste form.

In specific embodiments, said capsule/container is made of any suitable material that is resistant to corrosion by the fuel inside the fuel tank. Non-limiting examples of such materials are metals, alloys, plastics, polycarbonate, rubber, etc. In a specific embodiment, the capsule/container is a mere thin layer of fuel-resistant material holding the fire suppressant in place and isolating it from the fuel. The term thin may refer even to a nanometer thick layer.

Various improvements of the methods and systems according to the present invention are possible. For instance, the system may be connected to pipes in the fuel system and/or oil system, such that upon activation thereof the flow of fuel and/or oil in the engine stops to thereby minimize the amount of potential fire-fuel, which reduces the risk of fire.

Another improvement is associating the system with an external fire extinguishing system that is designed to cool the engine area and/or spread additional (other) fire suppressants outside the fuel tank. Examples of cooling materials are coolant air, nitrogen, carbon dioxide, water, aqueous solutions of sodium salts and potassium salts, etc.

Although the invention has been described in detail, nevertheless changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

1. A vehicle fire prevention system, comprising:
(a) a sealed container with an integral opening mechanism attached to the inner wall of a vehicle's fuel tank;
(b) a fire suppressant residing within said container; and
(c) a controller connected to one or more emergency sensors and to a fuel gage sensor, said controller designed to activate said opening mechanism,
wherein upon occurrence of an emergency situation detected by said one or more emergency sensors, the controller activates said opening mechanism to release a measured amount of said fire suppressant into said fuel tank, said measured amount being calculated according to the amount of fuel within the fuel tank as indicated by said fuel gage sensor.

2. The fire prevention system of claim 1, wherein said sealed container further comprises a fire suppressant dispersion mechanism activated by said controller during activation of said opening mechanism.

3. The fire prevention system of claim 2, wherein said dispersion mechanism is an explosive composition that is insensitive to ordinary handling and environmental conditions but is detonated instantly upon activation by said controller.

4. The fire prevention system of claim 1, wherein said one or more emergency sensors comprise any one of: a thermometer for detecting a fire or excessive heat; an accelerometer for detecting a crash/collision; and an airbag opening sensor; or any combination thereof.

5. The fire prevention system of claim 1, wherein said controller further receives data from the vehicle's airbag system, such that activation of the vehicle's airbag system serves as an indication to the controller to release said fire suppressant.

6. The fire prevention system of claim 1, wherein said fire suppressant comprises aluminum oxide, antimony oxide, sodium bicarbonate, or potassium carbonate.

7. The fire prevention system of claim 1, wherein said emergency situation is selected from an accident, a collision, an extraordinary impact, a fire, excessive heat, or any combination thereof.

8. A method for preventing fire outbreak within a vehicle's fuel tank or expulsion thereof, the method comprising attaching a fire suppressant sealed container as defined in any one of the preceding claims to the inner wall of said vehicle's fuel tank, such that upon occurrence of an emergency situation detected by said one or more emergency sensors, the controller activates said opening mechanism to release a measured amount of said fire suppressant into said fuel tank, said measured amount being calculated according to the amount of fuel within the fuel tank as indicated by said fuel gage sensor, thereby preventing fire outbreak or expulsion.

9. The method of claim 8, further comprising a step of connecting the controller to the vehicle's airbag system, such that activation of said airbag system also activates the controller to release said fire suppressant.

10. The method of claim 8, wherein the activation of said controller is automatic in response to an emergency situation.

11. The method of claim 8, wherein the activation of said controller is manual.

12. The method of 8, wherein said emergency situation is selected from an accident, a collision, an extraordinary impact, a fire, excessive heat, or any combination thereof.

13. The method of claim 9, wherein the activation of said controller is automatic in response to an emergency situation.

14. The method of claim 9, wherein the activation of said controller is manual.
